(19) United States
(12) Patent Application Publication
(10) Pub. No.: US 2014/0095554 A1
(43) Pub. Date: Apr. 3, 2014

(54) System And Method For Storing Equipment Management Operations Data

(71) Applicants: Hubertus V. Thomeer, Houston, TX (US); Edwin Guy Faught, Argyle, TX (US); Kay Stefan Capps, College Station, TX (US); Kyle Charles Marshall, College Station, TX (US)

(72) Inventors: Hubertus V. Thomeer, Houston, TX (US); Edwin Guy Faught, Argyle, TX (US); Kay Stefan Capps, College Station, TX (US); Kyle Charles Marshall, College Station, TX (US)

(21) Appl. No.: 13/631,432

(22) Filed: Sep. 28, 2012

(51) Int. Cl. G06F 17/30

(52) U.S. Cl. 707/821; 707/E17.01

(57) ABSTRACT

A management operations data tracking system and method are disclosed. The management operations data tracking system has one or more processors and a non-transitory computer readable medium storing computer executable instructions. The computer executable instructions cause the one or more processor to receive equipment operations parameter data indicative of an operating status of one or more equipment. The equipment operations parameter data is translated relative to a threshold level. A log is created for the one or more equipment and within the log one or more log entry is created indicative of the operation at sequential instants of time of the one or more equipment. The translated equipment operations parameter data is segmented and stored within the one or more log entry for the one or more equipment. The translated and segmented data is then transmitted and synchronized with a central hub. The equipment can be wellsite equipment.

### BACKGROUND

The statements made herein merely provide information related to the present disclosure and may describe some embodiments illustrating the invention.

Embodiments disclosed herein generally relate to systems or methods for facilitating, capturing, tracking, synthesizing, analyzing, managing and/or utilizing wellsite maintenance data for equipment. Embodiments disclosed herein also relate to systems or methods for determining degradation conditions of equipment or predicting residual life of equipment before, during, and after an oilfield operation. Examples of such oilfield operations include, but are not limited to, hydraulic fracturing, acid stimulation, cementing, etc.

In some embodiments, the equipment being maintained includes positive displacement pumps, sometimes referred to as reciprocating pumps. Positive displacement pumps are generally used in oilfield operations to pump fluids into a wellbore and the surrounding reservoir.

A given reciprocating pump may comprise one or more pump chambers that each receives a reciprocating plunger. When multiple chambers are enclosed in a reciprocating pump, the reciprocating pump is also called a multiplex pump. In any event, in a typical reciprocating pump, as the plunger is moved in one direction by the rotating crankshaft, fluid is drawn into the pump chamber through a one-way suction valve. Upon reversal of the plunger motion, the suction valve is closed and the fluid is forced outwardly through a discharge valve. The continued reciprocation of the plunger continues the process of drawing fluid into the pump and discharging fluid from the pump. The discharged fluid can be routed through tubing to a desired location, such as into a wellbore.

Multiplex pumps may have two sections: (a) a power end, the motor assembly that drives the pump plungers (the driveline and transmission are parts of the power end); and (b) a fluid end, the pump container that holds and discharges pressurized fluid. In triplex pumps, the fluid end has three fluid cylinders. In quintuplex pumps, the fluid end has five fluid cylinders. A fluid end may comprise a single block having the cylinders bored therein, commonly referred to as a monoblock fluid end. The individual cylinders can be bored in a single block, and subsequently multiple blocks are connected together to form an assembled fluid end, commonly referred to as a split fluid end. Embodiments of the current disclosure can be applied to multiplex pumps with monoblock fluid ends, split fluid ends, or other variations thereof.

One particularly useful application of the multiplex pump is hydraulic fracturing, where a fluid is pumped down a wellbore at a flow rate and pressure sufficient to fracture a subterranean formation. After the fracture is created or, optionally, in conjunction with the creation of the fracture, proppants may be injected into the wellbore and into the fracture. The proppant is a particulate material added to the pumped fluid to produce slurry, which is often very abrasive and/or corrosive. Pumping this slurry at the appropriate flow rate and pressure may be a severe pump duty. In fracturing operations each pump may pump up to twenty barrels per minute at pressures up to 20,000 psi. The pumps for this application are quite large and are frequently moved to the oilfield on semi-trailer trucks or the like. Many times a single multiplex pump will occupy the entire truck trailer. These pumps are connected together at the well site to produce a pumping system which may include several multiplex pumps. A sufficient number of pumps are connected to a common line to produce the desired volume and pressure output. For example, some fracturing jobs have up to 36 pumps.

Since fracturing operations are desirably conducted on a continuous basis, the disruption of a fracture treatment because of a failure of surface equipment is costly, time consuming, inefficient, and unproductive. Further, when such massive pumps are used, it is difficult in some instances to determine, in the event of a pump failure, which pump has failed. Because of the severe pump duty and the frequent failure rate of such pumps, it is normal to take thirty to one hundred percent excess pump capacity to each fracture site. The excess pump capacity may take additional capital to acquire the additional multiplex pumps and considerable expense to maintain the additional pumps and to haul them to the site. Therefore, multiplex pumps and other surface equipment are frequently disassembled and inspected before and after each fracture treatment and, in some instances, routinely rebuilt before or after each fracture treatment in an attempt to avoid equipment failures during subsequent fracture treatments.

Traditionally, wellsite maintenance data of multiplex pumps or any other wellsite equipment is recorded manually on paper or in Excel spreadsheets by field engineers at the wellsite. The maintenance data is then communicated from the wellsite to a central data location via telephone or e-mail. Sometimes, the maintenance data is not communicated to the central data location or gets lost during transmission. If the wellsite data safely arrives at the central data location, it is traditionally entered into a variety of computer databases by clerks or administrators at the central data location. One prominent issue associated with the traditional method is that the data capturing and transmitting process is not automated and any breakdown in the process may cause delay or failure to the equipment. Another problem with the conventional method is that it is not uniformly executed across operations; therefore, the data received at the center may be corrupted or missing information. When the maintenance data is incomplete or inaccurate, it is difficult for the management to determine what maintenance is needed, when maintenance is needed, and which equipment (or a component of equipment) on which maintenance should be performed, where the equipment is currently located, which location(s) the equipment has been deployed in its life, etc.

In addition to maintenance data, fracturing operations may produce operations data related to the functioning of wellsite equipment. Although operations data is useful for fracture operations at the location of the wellsite, the operations data may also be useful for management purposes, where it may be helpful to consider the production, maintenance, and operations issues of multiple wellsites in order to schedule fracturing operations, schedule maintenance, procure additional equipment, procure parts, and other considerations. However, fracturing operations are often conducted in geographically remote areas, which may have poor or no connectivity to a communications network. Where fracturing operations are able to access a communications network, the connectivity to the communications network may be unreliable or have low data transmission rates. Unreliable connections may lead to loss of data or data corruption during transmission of the data across the network. The resulting loss of data and data corruption may create gaps within the operations data viewed for management purposes and archival purposes. Low transmission rates may inhibit the types and amount of data transmitted across the unreliable communications network.

In these respects, the current disclosure aims to provide a method and system to capture operations data produced at the wellsite that addresses the above-mentioned problems, and more specifically the current disclosure relates to methods and systems to facilitate, capture, track, translate, transmit, and synchronize wellsite operations data so that fracturing operations and equipment may be observed and managed from a central hub. The transmission and synchronization of wellsite operations data to the central hub may facilitate centralized management of a plurality of fracturing operations and equipment. The following detailed description is provided in the context of fracturing operations using triplex pumps. However, it should be noted that embodiments of the current disclosure can be applied to any other oilfield operation or wellsite equipment operation.

### SUMMARY OF THE DISCLOSURE

This summary is provided to introduce a selection of concepts that are further described below in the detailed description. This summary is not intended to identify key or essential features of the claimed subject matter, nor is it intended to be used as an aid in limiting the scope of the claimed subject matter.

According to an aspect of the present disclosure, certain embodiments relate to a maintenance tool unit provided with a processor and a computer readable medium coupled to the processor. The computer readable medium is non-transitory and local to the processor. The computer readable medium stores computer executable instructions, that when executed by the processor causes the processor to: (1) receive first equipment operations parameter data indicative of a first operating status of a first equipment at a first location, (2) receive second operations parameter data indicative of the second operating status of a second equipment at the first location, (3) translate the first and second equipment operations parameter data relative to a threshold level, (4) segment the translated first and second equipment operations parameter data to create first segmented translated data indicative of the first equipment operations parameter data, and second segmented translated data indicative of the second equipment operations parameter data, and (5) store the first segmented translated data in a first log, on the computer readable medium, and the second segmented translated data in a second log on the computer readable medium, with the first and second logs being parts of a first database. The first location can be a wellsite, for example.

According to another aspect of the present disclosure, embodiments relate to a method implemented by computer executable instructions running on a processor. In this method, (1) data indicative of an operating status of equipment at sequential instants of time is received, (2) the data indicative of the operating status of the equipment is translated relative to a threshold level to create translated data indicative of the operating status of the equipment at the sequential instants of time, (3) the translated data is segmented to create a first segmented translated data and a second segmented translated data indicative of the operating status of the equipment at different periods of time, and (4) the first and second segmented translated data is stored within a log local to the processor. The equipment can be wellsite equipment, that may be located at a wellsite when the data indicative of the operating status of the equipment is received.

According to another aspect of the present disclosure, a system is described for the translation and segmentation of sensor data from equipment. The system includes first equipment at a first location, a first maintenance tool unit at the first location, a central hub, and a second maintenance tool unit at a second location. The first maintenance tool unit comprises a first processor and a first computer readable medium coupled to and local to the first processor. The first computer readable medium is non-transitory and stores first computer executable instructions, that when executed by the first processor causes the first processor to: (1) receive and store first management operations data indicative of first equipment operations parameter data indicative of a first operating status of a first equipment in a first log of a first database on the first computer readable medium, the first management operations data being translated and segmented from the first equipment operations parameter data; (2) store a first unique identification code identifying the first equipment, and a second unique identification code identifying the first maintenance tool unit in the first log. The central hub has a second processor storing a second database on a second computer readable medium separate from the first computer readable medium. The second computer readable medium is non-transitory. The second processor synchronizes the first database with the second database, whereby the first log is stored in the second database. The second maintenance tool unit comprises a third processor storing a third database on a third computer readable medium. The third computer readable medium is non-transitory and separate from the first and second computer readable mediums. The third processor synchronizes the third database with the second database, whereby the first log is stored in the third database. The first location can be a first wellsite, and the second location can be a second wellsite.

According to yet another aspect of the present disclosure, another method is described. In this method, a first database is created on a first computer readable medium. The first computer readable medium is non-transitory and local to a first maintenance tool unit. A second database is created on a second computer readable medium. The second computer readable medium is non-transitory and local to a second maintenance tool unit. Management operations data indicative of equipment operations parameter data is stored within the first and second databases. The equipment operations parameter data is indicative of an operating status of equipment located locally to the first and second maintenance tool units. The management operations data is created by translating and segmenting the equipment operations parameter data. The management operations data stored in the first and second databases is synchronized with a third database stored on a third computer readable medium at a central hub. The third computer readable medium is non-transitory. The equipment can be wellsite equipment, or other types of equipment.

### BRIEF DESCRIPTION OF THE DRAWINGS

To assist those of ordinary skill in the relevant art in making and using the subject matter hereof, reference is made to the appended drawings, which are not intended to be drawn to scale, and in which like reference numerals are intended to refer to similar elements for consistency. For purposes of clarity, components may be labeled in certain ones of the drawings but not in each drawing.

FIG. 1 is a schematic representation depicting equipment for performing an oilfield operation on a well in accordance with an embodiment disclosed herein.

FIG. 2 is a schematic representation depicting an oilfield operation in accordance with an embodiment disclosed herein.

FIG. 3 is a schematic flow diagram illustrating health monitoring of an oilfield operation in accordance with an embodiment disclosed herein.

FIGS. 4.1-4.7 are schematic illustrations depicting example screenshots of a communication interface in accordance with an embodiment disclosed herein.

FIG. 5 is a schematic representation depicting a computerized control system in accordance with an embodiment disclosed herein.

FIG. 6 is a schematic representation depicting a system for management operations data tracking.

FIG. 7 is a flow diagram illustrating management operations data tracking in accordance with an embodiment disclosed herein.

FIG. 8 is a schematic diagram of one embodiment of translating management operations data into a format suitable for distribution from a wellsite to a centralized hub, in accordance with an embodiment disclosed herein.

FIG. 9 is a schematic representation depicting a display of management operations data in accordance with an embodiment disclosed herein.

FIG. 10 is a schematic diagram depicting a redundant distributed database in accordance with an embodiment disclosed herein.

FIG. 11 is a schematic diagram depicting a synchronization process in accordance with an embodiment disclosed herein.

FIG. 12 is a schematic diagram depicting a heartbeat synchronization process in accordance with an embodiment disclosed herein.

FIG. 13 is a schematic diagram depicting a display of heartbeat synchronization information in accordance with an embodiment disclosed herein.

FIG. 14 is a schematic diagram depicting a quick synchronization process in accordance with an embodiment disclosed herein.

FIG. 15 is a schematic diagram depicting a log in accordance with an embodiment disclosed herein.

FIG. 16 is a schematic diagram depicting a full synchronization process in accordance with an embodiment disclosed herein.

FIG. 17 is a schematic diagram depicting a process for displaying management operations data in accordance with an embodiment disclosed herein.

### DETAILED DESCRIPTION

Specific embodiments of the present disclosure will now be described in detail with reference to the accompanying drawings. It is to be understood that the various embodiments, although different, are not necessarily mutually exclusive. For example, a particular feature, structure, or characteristic described herein in connection with one embodiment may be implemented within other embodiments without departing from the spirit and scope of the present disclosure. Further, in the following detailed description of embodiments of the present disclosure, numerous specific details are set forth in order to provide a more thorough understanding of the present disclosure. However, it will be apparent to one of ordinary skill in the art that the embodiments disclosed herein may be practiced without these specific details. In other instances, well-known features have not been described in detail to avoid unnecessarily complicating the description.

It should also be noted that in the development of any such actual embodiment, numerous decisions specific to circumstance may be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Furthermore, the description and examples are presented solely for the purpose of illustrating the different embodiments, and should not be construed as a limitation to the scope and applicability. While any composition or structure may be described herein as comprising certain materials, it should be understood that the composition could optionally comprise two or more different materials. In addition, the composition or structure can also comprise some components other than the ones already cited. Although some of the following discussion emphasizes the use of the systems at a wellsite to facilitate and/or assist in managing wellsite operations, it should be understood that the systems described herein could be used at locations other than a wellsite. For example, the systems can be used to monitor equipment at construction sites, mines or the like. Although some of the following discussion emphasizes fracturing, the equipment, compositions and methods may be used in any well treatment in which diversion is needed. Examples include fracturing, acidizing, water control, chemical treatments, and wellbore fluid isolation and containment. Embodiments will be described for hydrocarbon production wells, but it is to be understood that they may be used for wells for production of other fluids, such as water or carbon dioxide, or, for example, for injection or storage wells. It should also be understood that throughout this specification, when a range is described as being useful, or suitable, or the like, it is intended that any value within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each possible number along the continuum between about 1 and about 10. In other words, when a certain range is expressed, even if a few specific data points are explicitly identified or referred to within the range, or even when no data points are referred to within the range, it is to be understood that the inventors appreciate and understand that any data points within the range are to be considered to have been specified, and that the inventors have possession of the entire range and points within the range.

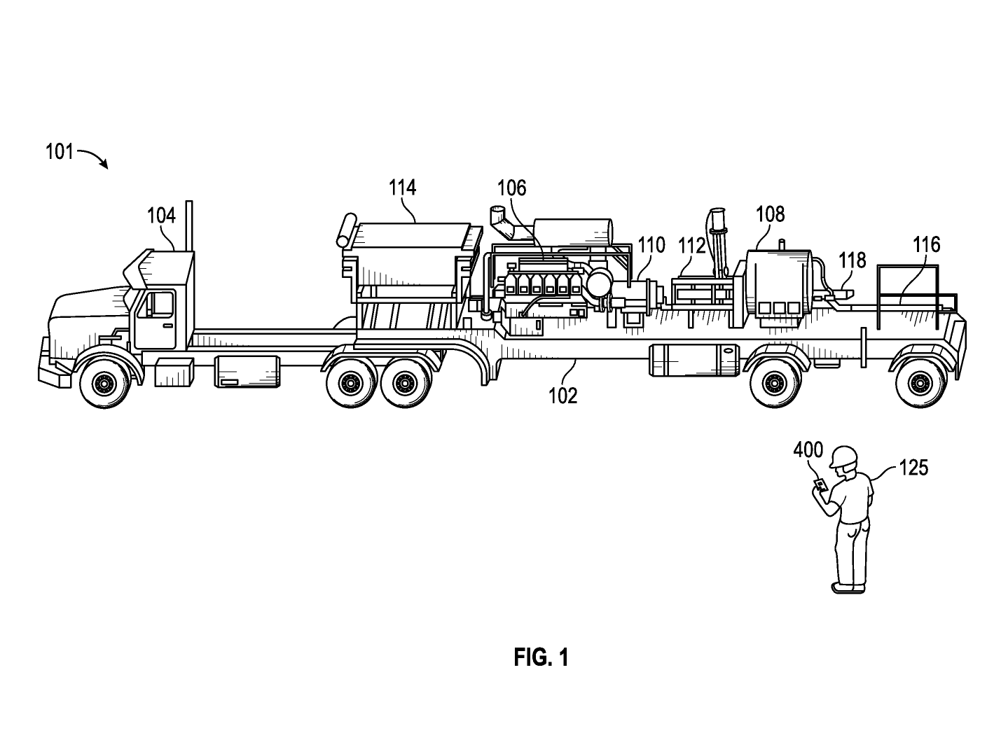

Referring to the drawings, illustrations and pictures, and in particular FIG. 1, one example of a monitored piece of equipment is illustrated therein. The equipment can be wellsite equipment or equipment that has not been adapted or configured for use at a wellsite. For example, a pumping unit 101 is depicted for pumping a fluid from a well surface to a wellbore. As shown, the pumping unit 101 includes a plunger pump and fluid end 108 mounted on a standard trailer 102 for ease of transportation by a tractor 104. The pumping unit 101 includes a prime mover 106 that drives a crankshaft through a transmission 110 and a drive shaft 112. The crankshaft, in turn, drives one or more plungers toward and away from a chamber in the pump fluid end 108 in order to create pressure oscillations of high and low pressures in the chamber. These pressure oscillations allow the pump to receive a fluid at a low pressure and discharge it at a high pressure via one way valves (also called check valves). Also connected to the prime mover 106 is a radiator 114 for cooling the prime mover 106. In addition, the pump fluid end 108 includes an intake pipe 116 for receiving fluid at a low pressure and a discharge pipe 118 for discharging fluid at a high pressure.

A field operator, equipment operator or field engineer 125 is depicted therein for recording maintenance data, and/or performing maintenance operations. For example, the field operator 125 may check the oil, check the transmission fluid, change the seals and check for leakage, among many other maintenance related operations known in the art. As will be explained in more detail below, the engineer 125 may acquire and/or record data relating to maintenance using a handheld data acquisition device, computer, touch screen computer or communication interface device 400. The field operator 125 can input data into the handheld device 400 at a location nearby the pumping unit 101 under inspection or maintenance. The field operator 125 can then transmit the acquired data to a central data server using either a nearby computer, or a communication network if the communication interface device 400 is equipped with network connecting capability.

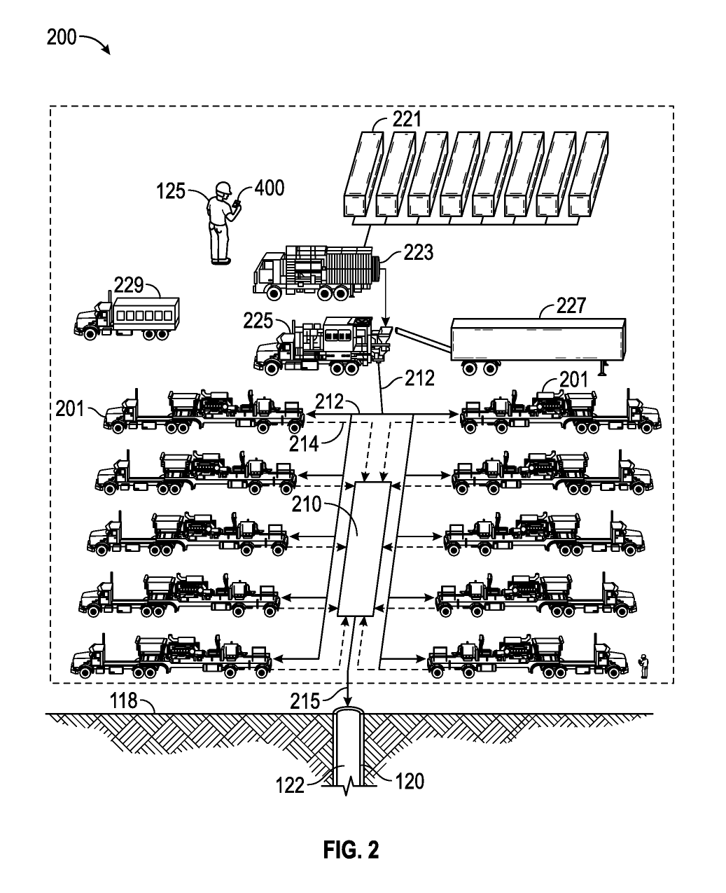

Referring now to FIG. 2, one example of an oilfield operation is shown with a field operator 125 depicted therein for recording maintenance and operational data on a communication interface device 400, and/or performing maintenance in accordance with a prescribed maintenance plan. A pumping system 200 is shown for pumping a fluid from a surface 118 of a well 120 to a wellbore 122 during an oilfield operation. In this particular example, the operation is a hydraulic fracturing operation, and hence the fluid pumped is a fracturing fluid. As shown, the pump system 200 includes a plurality of water tanks 221, which feed water to a gel hydration unit 223. The gel hydration unit 223 combines water from the tanks 221 with a gelling agent to form a gel. The gel is then sent to a blender 225 where it is mixed with a proppant from a proppant transport 227 to form a fracturing fluid. The gelling agent increases the viscosity of the fracturing fluid and allows the proppant to be suspended in the fracturing fluid. It may also act as a friction reducing agent to allow higher pump rates with less frictional pressure.

The fracturing fluid is then pumped at low pressure (for example, around 60 to 120 psi) from the blender 225 to a plurality of pumping units 201 as shown by solid lines 212. Note that each pumping unit 201 in the embodiment of FIG. 2 may have the same or a similar configuration as the pumping unit 101 shown in FIG. 1. As shown in FIG. 2, each pumping unit 201 receives the fracturing fluid at a low pressure and discharges it to a common manifold 210 (sometimes called a missile trailer or missile) at a high pressure as shown by dashed lines 214. The missile 210 then directs the fracturing fluid from the pumping units 201 to the wellbore 122 as shown by solid line 215.

In a typical hydraulic fracturing operation, an estimate of the well pressure and the flow rate to create the desired side fractures in the wellbore is calculated. Based on this calculation, the amount of hydraulic horsepower needed from the pumping system in order to carry out the fracturing operation is determined. For example, if it is estimated that the well pressure and the flow rate are 6000 psi (pounds per square inch) and 68 BPM (Barrels Per Minute), then the pump system 200 would need to supply 10,000 hydraulic horsepower to the fracturing fluid (i.e., 6000*68/40.8).

In one embodiment, the prime mover 106 in each pumping unit 201 is an engine with a maximum rating of 2250 brake horsepower, which, when accounting for losses (which may be about 10% for plunger pumps in hydraulic fracturing operations), allows each pumping unit 201 to supply a maximum of about 2025 hydraulic horsepower to the fracturing fluid. Therefore, in order to supply 10,000 hydraulic horsepower to a fracturing fluid, the pump system 200 of FIG. 2 may have at least five pumping units 201.

In order to prevent an overload of the transmission 110, and for various other reasons, each pumping unit 201 is normally operated well under its maximum operating capacity. Operating the pumps under their operating capacity also allows for one pump to fail and the remaining pumps to be run at a higher speed in order to make up for the absence of the failed pump.

As such in the example of a fracturing operation requiring 10,000 hydraulic horsepower, bringing ten pumping units 201 to the wellsite enables each pump engine 106 to be operated at about 1111 brake horsepower (about half of its maximum) in order to supply 1000 hydraulic horsepower individually and 10,000 hydraulic horsepower collectively to the fracturing fluid. On the other hand, if ten pumping units 201 are brought to the wellsite, or if one of the pumps fails, then each of the ten pump engines 106 would be operated at about 1234 brake horsepower in order to supply the 10,000 hydraulic horsepower to the fracturing fluid. As shown, a computerized control system 229 may be employed to direct the entire pump system 200 for the duration of the fracturing operation.

In performing the example operation as described above at the desired pressure, flow rate, and hydraulic horsepower, numerous opportunities for equipment failure are present. Accordingly, in one aspect, the current disclosure provides a system and method to facilitate/capture and use wellsite maintenance data that allows an understanding of the state of equipment, location of equipment and equipment maintenance cost. In another aspect, the current disclosure provides a system and method to facilitate/capture and use wellsite maintenance data that is user interactive to provide a common language that is easily understood and uses existing well site infrastructure to locate where equipment is located. Other location identifiers such as GPS, barcode, RFID-Tag, etc. are optional. In a further aspect, the current disclosure provides a system and method to facilitate/capture and use wellsite maintenance data that provides a seamless method to provide each asset with prior health status (e.g., maintenance history, usage, operational history, manufacturer information, location data, and the like) which follows the asset when it moves from location to location, therefore reducing the need for unnecessary maintenance due to lack of such health status. In yet another aspect, the current disclosure provides a system and method to facilitate/capture and use wellsite maintenance data that enables remote monitoring of wellsite maintenance, remote inputting of wellsite maintenance, and automated recording of maintenance data.

The operation of the current disclosure is further illustrated in the context of a health monitoring maintenance tool 300 for monitoring and maintaining the fluid end of a multiplex pump, such as a triplex pump, in a fracturing operation. However, it should be noted that any other oilfield operations and equipment can be used in the current disclosure as well.

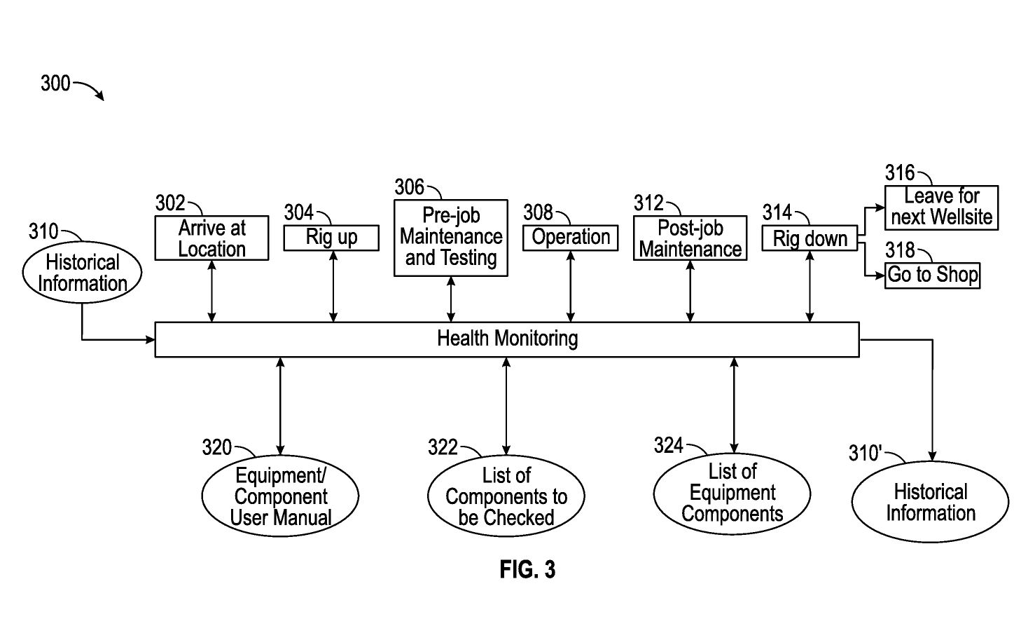

Referring now to FIG. 3, an example work flow illustrating health monitoring 300 of an oilfield operation, or fracturing job, is shown. Allowing for some variation: in operation, the equipment 101 first arrives at a wellsite location 302 and is rigged up 304. Upon arrival 302, the equipment 101 may be registered by the field operator 125 with the communication interface device 400, or the location of the equipment 101 may be known by the field operator 125 due to other location identifiers, such as GPS or the like. As the location of equipment 101 is known or registered, the operator sees a depiction of the equipment 101 via the communication interface and may access the equipment's prior health status 310 along with other relevant wellsite-related data (e.g. current job description, modeling data, and the like). The prior health status 310 and other relevant wellsite data may be located and stored on an off-site database, central data server or the computerized control system 229, which is accessible by the communication interface device 400 via a wireless communication network connection. Therefore, prior to performing a well operation 308, the equipment operator 125 is provided with historical information 310 in order to see what maintenance and/or testing should be performed pre-job 306, during the job 308, or post-job 312. For example, most fracturing jobs pump one or more stages in an operation 308, thus post-job maintenance 312 may be performed after each stage or after a certain number of pump hours have been reached.

The field operator 125 is enabled to monitor the equipment 101 throughout the job, and record both observations and maintenance. Upon completion of the job 308 and any post-job maintenance 312, the equipment 101 is rigged down (i.e., disassembled) 314 and either sent to another wellsite location 316 or sent to the shop 318 for more maintenance and repair. The health status of the equipment is updated 310′ upon each recorded maintenance operation, and the health monitoring 300 may continue as the equipment 101 moves from one location to the next.

Using the monitored maintenance data, a field supervisor or market manager may better manage a fleet of equipment units 101 by knowing what units 101 are in operation, not in operation or being maintained. As such, the market manager is better able to plan maintenance and operation of the fleet of monitored equipment units 101.

In one embodiment, where connection to the communication network is problematic, the communication interface device 400 may be equipped with a storage medium for saving the recorded observations and maintenance on the device 400 until it can be uploaded to the central data server when connection is re-established.

In one aspect, the communication interface device 400 may generate work orders that can be sent to, or otherwise accessible by, the next equipment operator 125 or maintenance repair person. The maintenance performed and recorded in the communication interface device 400 may be synced through the network access to the central data server. The maintenance shop, district management, logistics and procurement can use the data to manage the equipment maintenance, location and operations. As equipment moves to another wellsite 316, a communication interface device 400 located at the new wellsite identifies the equipment's updated health status 310′ and can monitor the equipment and send data to the server.

In prescribing maintenance, the health monitoring maintenance tool 300 performs such analysis based on factors, such as: what prior operations were performed with the particular equipment; how was the equipment used in prior operations; what are the job parameters of the current operation to be performed; what are the other equipment units on site to be connected to the equipment for performing the oilfield operation; how many total hours has the equipment been used; mean time between failure of the equipment; what reliability checks should be performed at the current hours of operation; what previous maintenance operations were performed; what current state is the equipment in; or the like. Therefore, the field operator 125 receives a prescribed list, or checklist, of maintenance components to be checked, or operations to be performed 322 that is unique to the job and unique to the specific equipment 101. Such prescribed maintenance using the health monitoring maintenance tool 300 may save time, and may be more efficient, than methods of standard checklists of maintenance operations to be performed for each job regardless of any extenuating factors, such as those listed above as an example. Thus, the disclosed health monitoring maintenance tool 300 enables the field operator to deliver better service quality at a lower cost of ownership.

In monitoring the equipment 101, the health monitoring maintenance tool 300 may communicate with sensors located on the equipment, for example via the control system 229, and monitor trends of operation, for example: rate vs. pressure, temperature over time, pressure and temperature over time, torque converter temperature over time, and the like. Such data is filtered into the analysis of the health monitoring maintenance tool 300 and used to prescribe potential maintenance or sound certain alarms when a monitored trend is outside of predetermined boundaries.

The communication interface device 400 of the health monitoring maintenance tool 300 may provide an interactive user experience. For example, the communication interface may be touch screen operable, allowing the field operator 125 to easily input maintenance-related data, and visually see depictions of the equipment on which maintenance is to be performed.

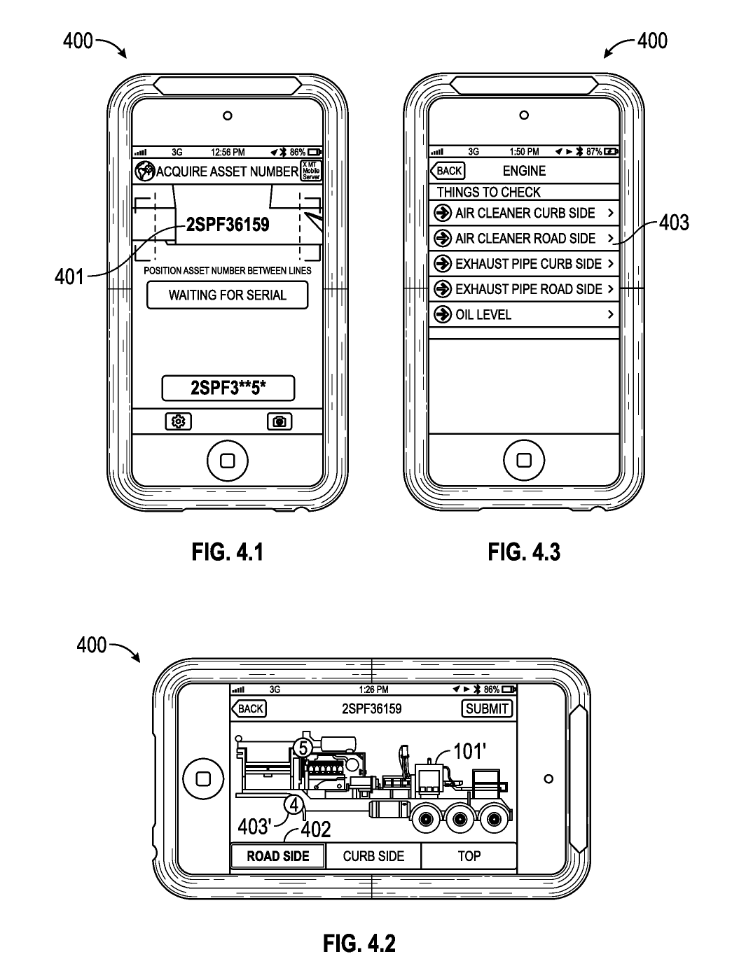

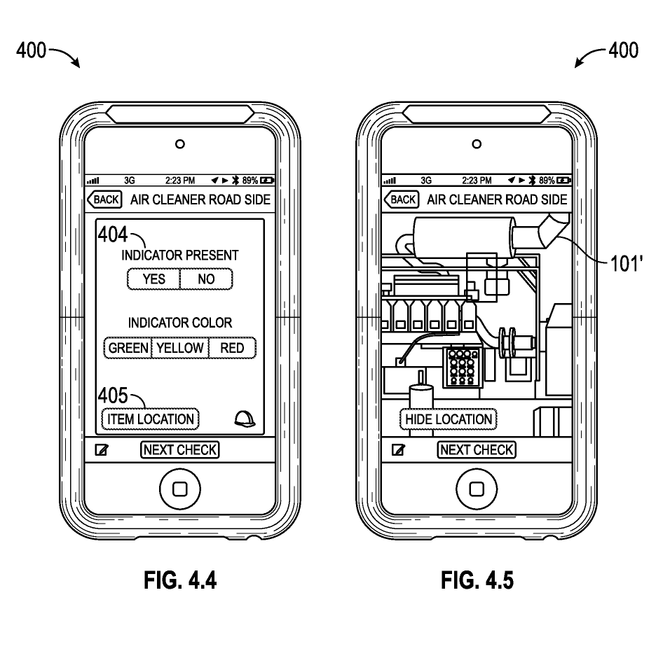

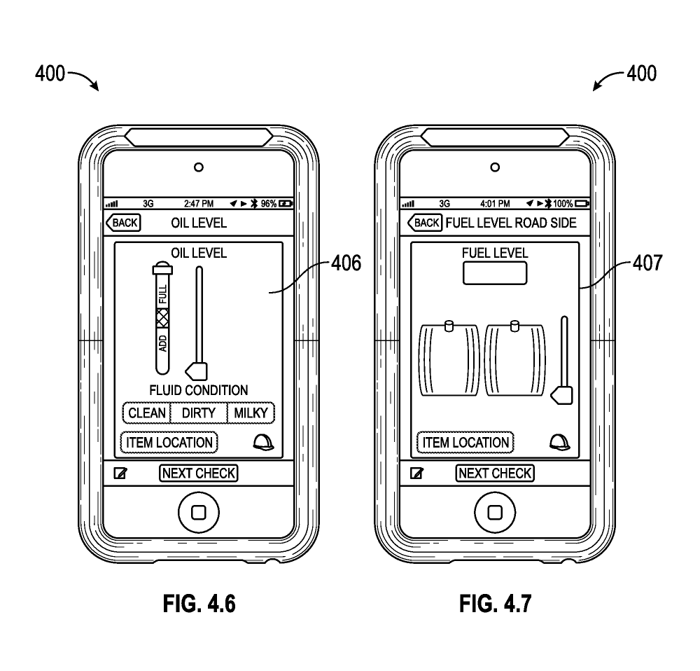

Referring now to FIGS. 4.1-4.7, example screenshots of the communication interface device 400 are shown. In FIG. 4.1 particularly, the communication interface device 400 may be used to acquire the equipment identification 401 (e.g., serial number, asset number) of the equipment 101. The equipment identification 401 may be captured using RFID tags implanted or printed on the equipment 101, or likewise may be captured using the serial number already printed on the equipment 101. For example, the communication interface device 400 may comprise hardware and software for recognizing the serial number and verifying the recognition with the central data server. In operation, the equipment operator 125 may use a camera on the communication interface device 400 to take a picture or scan the equipment identification 401 via OCR (optical character recognition). The picture, or data related to the serial number, may then be sent to the central data server where said data may be cross-checked with related data on a database. Once the equipment is recognized via the equipment identification 401, the health monitoring maintenance tool 300 sends the operator 125, via a communication network, the prescribed list of maintenance operations that should be performed, if any. As explained herein, the operator 125 may also access prior health status 310 of the equipment, as well as the equipment/component user manual 320 and list of equipment components 324.

In FIGS. 4.2 and 4.3, an example of a prescribed list 403 of maintenance operations is shown for the equipment 101 identified in FIG. 4.1. As shown, the list 403 may be graphically illustrated as shown in FIG. 4.2 and/or may be textually presented as shown in FIG. 4.3.

Referring now to FIGS. 4.4 and 4.5, an example detailed action from the prescribed list 403 is shown. Provided the action item 404, the operator 125 may request that the particular item location 405 to be shown. As shown in FIG. 4.5, an illustration/depiction of the equipment 101′ may be presented to help the operator 125 identify what needs to be checked or repaired. Referring to FIGS. 4.6 and 4.7, other examples of detailed actions from the prescribed list 403 are shown. In FIG. 4.6, the operator 125 may input the oil level 406 of a particular equipment unit. And in FIG. 47, the operator 125 may input the fuel level 407 of a particular equipment unit.

As described above, transmitting data from a wellsite operation to a centralized hub is fraught with problems including the use of an inconsistent and/or unreliable network connection such as a satellite communication system. In particular, satellite communications systems have a relatively low data rate and can be inconsistent due to factors such as cloud cover. The system and methods described below translate sensor data into a format which can be transmitted with a low data rate, and may use a synchronization method that overcomes the inconsistent nature of the network connection. Thus, the system and methods described below overcome the problems associated with transmitting data from a wellsite operation to a centralized hub.

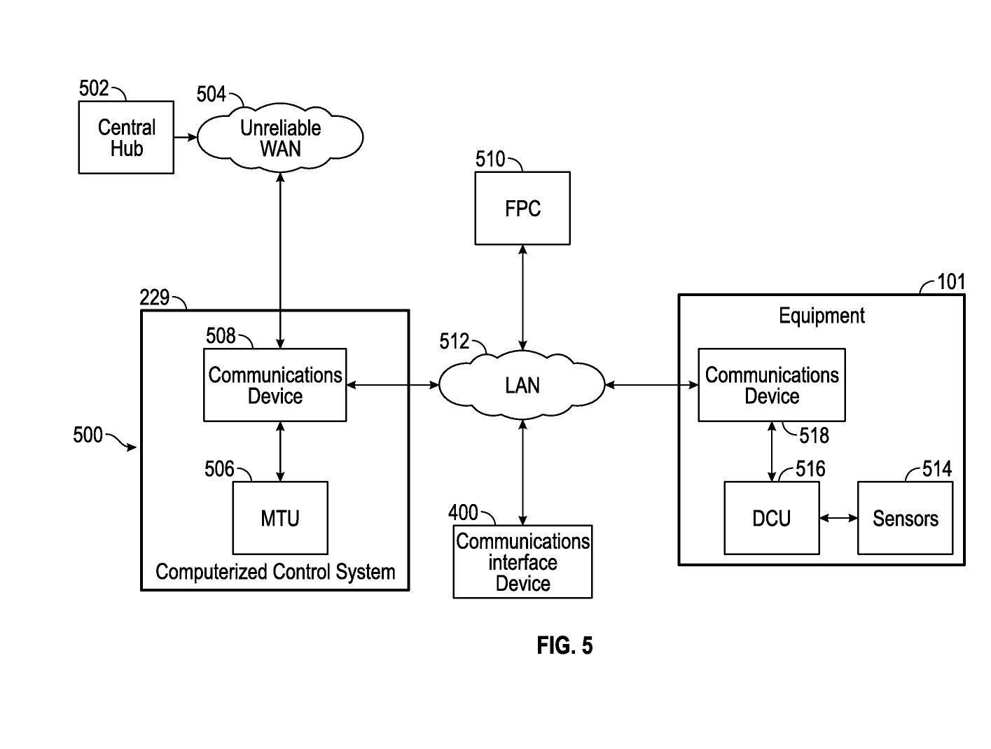

Referring now to FIG. 5 illustrated therein is one embodiment of a management data tracking system 500 that may be used to facilitate centralized management of the plurality of fracturing operations and equipment by translating operations data into a format suitable for transmission over a slow and/or unreliable network connection from a wellsite. Although the management data tracking system 500 will be described herein in connection with a wellsite, it should be understood that other applications are also contemplated including use of the management data tracking system 500 for facilitating management of other types of equipment such as trucks, backhoes, bulldozers at a mine, a construction site or the like. In one embodiment the management data tracking system 500 may comprise the computerized control system 229, equipment 101, and a central hub 502. The computerized control system 229 translates real-time sensor data collected from equipment 101 into a format that can be entered into a database and reliably synced with the central hub 502 using a wide area communications network 504, such as a satellite communications network. The computerized control system 229 may comprise a maintenance tool unit (“MTU”) 506, and a communications device 508. The computerized control system 229 may be connected via the communications device 508 to a fracture pump controller (“FPC”) 510, communicating over a local communications network 512. The computerized control system 229 and the FPC 510 may be in communication with the equipment 101 and the communication interface device 400, each described above, via the local communications network 512. The equipment 101, as described above, may also be provided with a plurality of sensors 514, a data collection unit (“DCU”) 516, and a communications device 518.

The computerized control system 229, fracture pump controller 510, local communications network 512, equipment 101, communications interface device 400 may be located within a particular limited district such as a wellsite. The central hub 502 may be remote from the particular limited district and communicate with the computerized control system 229 via the wide area communications network 504.

The term “local” as used herein means within a single machine, within a single local area network or metropolitan area network, or within a network having separate local area networks communicating with each other through the use of a reliable high-speed communication link, such as a fiber optic cable, wireless point to point communicating link, or using an IEEE standard 802.11a, b, n or g communication link. For example, the central hub 502 may communicate with (1) a first local group of the computerized control systems 229, fracture pump controllers 510, local communications network 512, equipment 101, and communications interface device 400, and (2) a second local group of the computerized control systems 229, fracture pump controllers 510, local communications network 512, equipment 101, and communications interface device 400. The first group can be located at a first location, and the second group can be located at a second location, which may be 100 miles from the first location. In this example, the first location is remote to the second location, and the central hub 502 may be remote to the first and the second locations. The first and second locations can be wellsites, constructions sites or mines, for example.

The equipment 101, for the sake of clarity with regards to embodiments of the management data tracking system 500, will be described as a pump. However, it should be understood by one skilled in the art that the equipment 101 may be any equipment 101 which would benefit from remote operational monitoring, maintenance data collection, or control, and is capable of being employed with sensors. The equipment 101, as described above, may have various jobs within a hydraulic fracturing operation, such as pumping; mixing proppants and chemical additives; storing proppants, chemical additives, and fluids; receiving fluid from the wellsite; filtering fluid from the wellsite; and combinations thereof, for example.

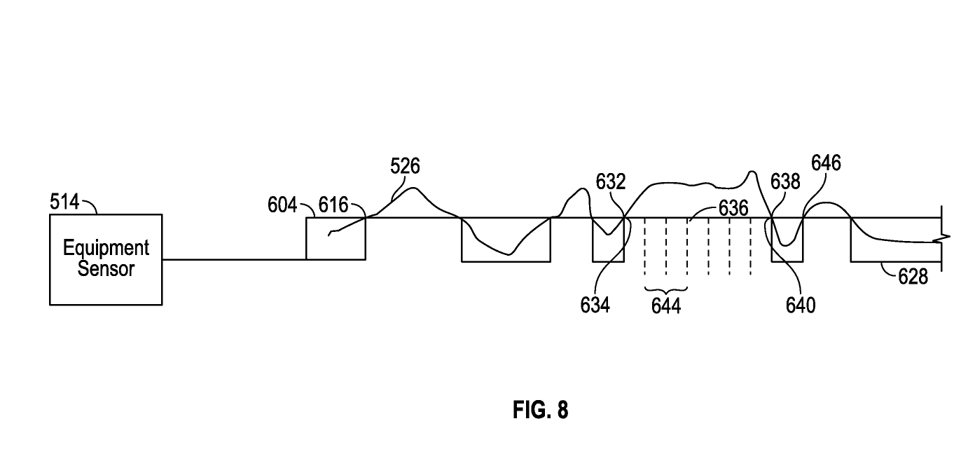

The FPC 510, in communication with a one or more of pumps 101 may control equipment operations functions of the pumps 101 while monitoring equipment operations parameter data 526 (FIG. 8) indicative of an operating status of the pumps 101. The FPC 510 may communicate the equipment operations parameter data 526 to the MTU 506 for monitoring, translating, and transmission to the central hub 502.

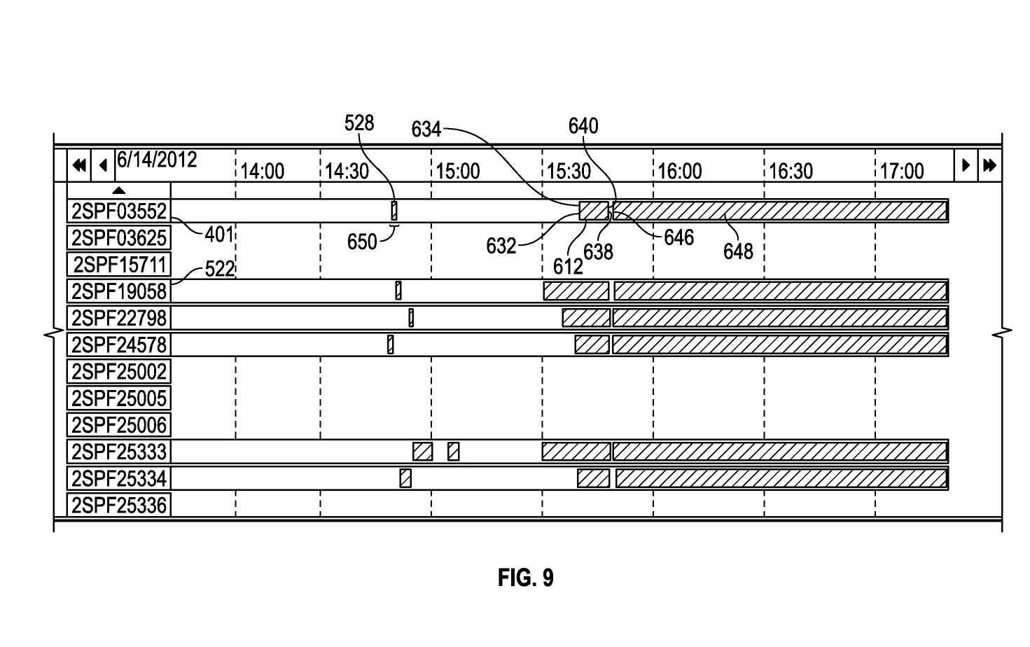

The MTU 506 may receive the equipment operations parameter data 526 from the FPC 510 and then translates the equipment operations parameter data 526 into management operations data 528. The MTU 506 may display the management operations data 528 (FIG. 9) to a user while segmenting the management operations data 528 into one or more logs, suitable for transmission to the central hub 502 across the wide area communications network 504, and stored on a database local to the MTU 506. The MTU 506 may then at intervals, or upon prompt, synchronize the data stored on the local database with the central hub 502.

The central hub 502 may receive the management operations data 528 from one or more MTU 506, creating a redundant distributed database 530. The central hub 502 may then synchronize the data from each of the plurality of MTU 506, stored in the redundant distributed database 530, with each of the plurality of MTU 506 such that each of the plurality of MTU 506 contain a local version of the redundant distributed database 530. The central hub 502 may also transmit the management operations data 528 from each of the plurality of MTU 506 to a management terminal 531, local to or remote from the central hub 502, such that a user may view the management operations data 528 from various ones of the plurality of MTU 506.

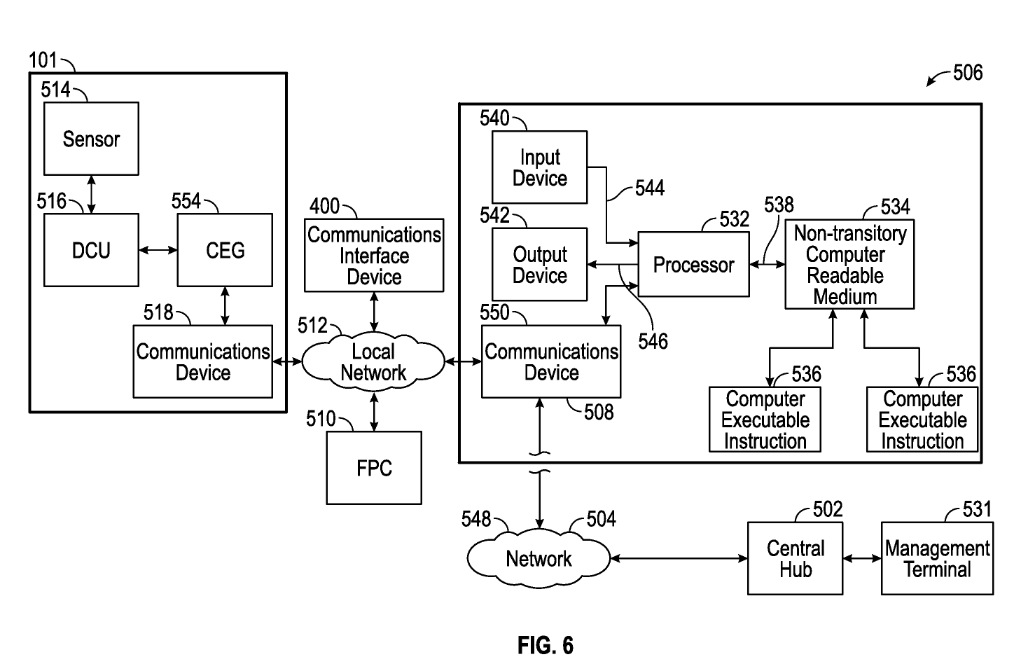

Referring now to FIG. 6, as shown therein, the MTU 506 may comprise a processor 532, a non-transitory computer readable medium 534, and computer executable instructions 536 stored on the non-transitory computer readable medium 534.

The one or more processors 532 may be implemented as a single processor 532 or multiple processors 532 working together or independently to execute the computer executable instructions described herein. Embodiments of the one or more processor 532 may include a digital signal processor (DSP), a central processing unit (CPU), a microprocessor, a multi-core processor, and combinations thereof. The processor 532 is coupled to the non-transitory computer readable medium 534. The non-transitory computer readable medium 534 can be implemented as random access memory, read only memory, flash memory or the like, and may take the form of a magnetic device, optical device or the like. The non-transitory computer readable medium 534 can be a single non-transitory computer readable medium, or multiple non-transitory computer readable medium functioning logically together or independently. The processor 532 is coupled to and configured to communicate with the non-transitory computer readable medium 534 via a path 538 which can be implemented as a data bus, for example. The one or more processor 532 may be capable of communicating with an input device 540 and an output device 542 via paths 544 and 546, respectively. Paths 544 and 546 may be implemented similarly to, or differently from path 538. For example, paths 544 and 546 may have a same or different number of wires and may or may not include a multidrop topology, a daisy chain topology, or one or more switched hubs. The paths 538, 544 and 546 can be a serial topology, a parallel topology, a proprietary topology, or combination thereof. The one or more processor 532 is further capable of interfacing and/or communicating with one or more network 548, via the communications device 550 such as by exchanging electronic, digital and/or optical signals via the communications device 550 using a network protocol such as TCP/IP. In one embodiment, the communications device 550 may be implemented as the communication device 508 of the computerized control system 229. The communications device 550 may be a wireless modem, digital subscriber line modem, cable modem, network bridge, Ethernet switch, or any other suitable communications device capable of communicating between the one or more processor 532 and the networks 512 and 548. It is to be understood that in certain embodiments using more than one processor 532, the one or more processor 532 may be located remotely from one another, located in the same location, or comprising a unitary multicore processor (not shown). The one or more processor 532 is capable of reading and/or executing computer executable instructions 536 and/or creating, manipulating, altering, and storing computer data structures into the non-transitory computer readable medium 534.

The non-transitory computer readable medium 534 stores computer executable instructions 536 and may be implemented as any conventional non-transitory computer readable medium 534, such as random access memory (RAM), a hard drive, a hard drive array, a solid state drive, a flash drive, a memory card, a CD-ROM, a DVD-ROM, a BLU-RAY, a floppy disk, an optical drive, and combinations thereof. When more than one non-transitory computer readable medium 534 is used, the non-transitory computer readable medium 534 may be located in the same physical location as the one or more processor 532, and non-transitory computer readable medium 534 may be located in a remote physical location from the one or more processor 532. The physical location(s) of the non-transitory computer readable medium 534 can be varied, and the non-transitory computer readable medium 534 may be implemented as a “cloud memory,” i.e. non-transitory computer readable medium 534 which is partially, or completely based on or accessed using the one or more network 548, so long as at least one of the non-transitory computer readable medium 534 is located local to the one or more processor 532.

The input device 540 transmits data to the one or more processor 532, and can be implemented as a keyboard, a mouse, a touch-screen, a camera, a cellular phone, a tablet, a smart phone, a PDA, a microphone, a network adapter, a camera, a scanner, and combinations thereof. The input device 540 may be located in the same physical location as the one or more processor 532, or may be remotely located and/or partially or completely network-based. The input device 540 communicates with the one or more processor 532 via path 544.

The output device 542 transmits information from the one or more processor 532 to a user, such that the information can be perceived by the user. For example, the output device 542 may be implemented as a server, a computer monitor, a cell phone, a tablet, a speaker, a website, a PDA, a fax, a printer, a projector, a laptop monitor, and combinations thereof. The output device 542 communicates with the one or more processor 532 via the path 546.

The one or more network 548 may permit bi-directional communication of information and/or data between the one or more processor 532 and the one or more network 548. The one or more network 548 may interface with the one or more processor 532 in a variety of ways, such as by optical and/or electronic interfaces, and may use a plurality of network topographies and protocols, such as Ethernet, TCP/IP, circuit switched paths, file transfer protocol, packet switched wide area networks, and combinations thereof. For example, the one or more network 548 may be implemented as the Internet, a LAN, a wide area network (WAN), a metropolitan network, a wireless network, a cellular network, a GSM-network, a CDMA network, a 3G network, a 4G network, a satellite network, a radio network, an optical network, a cable network, a public switched telephone network, an Ethernet network, and combinations thereof. The one or more network 548 may use a variety of network protocols to permit bi-directional interface and communication of data and/or information between the one or more processor 532 and the one or more network 548.

In one embodiment, MTU 506 provided with the one or more processor 532, the non-transitory computer readable medium 534, the input device 540, the output device 542, and the communications device 550 may also be implemented together as a smartphone, a PDA, a tablet device, such as an iPad, a netbook, a laptop computer, a desktop computer, or any other computing device.

The non-transitory computer readable medium 534 may store the computer executable instructions 536 comprising a management data tracking program 552. The non-transitory computer readable medium 534 may also store other computer executable instructions 536 such as an operating system and application programs such as a word processor, for example. The computer executable instructions for the management data tracking program 552 and the other computer executable instructions 536 may be written in any suitable programming language, such as C++, C#, or Java.

The FPC 510 may be implemented similarly to the MTU 506, or may be implemented as computer executable instructions 536 within the MTU 506 stored on the non-transitory computer readable medium 534. In differing embodiments, the FPC 510 may be in communication with the communication device 518 and communication device 550. In one embodiment, the FPC 510 may control the equipment 101 and communicate equipment operation parameters data 526 to the MTU 506, via the communication device 508.

The pumps 101 may be implemented as plunger pumps, as described above. Each of the pumps 101 may further be provided with the plurality of sensors 514, the DCU 516, the communications device 518, and a controller area network to Ethernet gateway, CEG 554. The pumps 101 may communicate with the FPC 510 and the MTU 506 through the local communications network 512 via the communications device 518 and through the CEG 554.

The plurality of sensors 514 may detect and record one or more types of equipment operations parameter data 526 indicative of the operating status of the pumps 101. The operating status may indicate that the pumps 101 are operating or not operating. The equipment operations parameters data 526 comprising data indicating readings for pressure, temperature, flow rate, hours of operation, start time, of operation, and end time of operation, for example. The equipment operations parameters data 526 may be created through operation or lack of operation of the pumps 101, which operate within ranges of pressures, temperatures, and flow rates, for example. The equipment operation parameters 526 may comprise, for example, data indicative of equipment pressure, such as input pressure, output pressure, pressure oscillation, for example; data indicative of equipment flow rate, for instance the number of barrels of fluid per minute passing through a pump; and data indicative of equipment temperature. The pumps 101 may also operate continuously, for predetermined periods of time, or for indeterminate periods of time where the indeterminate periods of time may be caused by unplanned interruptions in operation. The plurality of sensors 514 receiving equipment operations parameter data 526 may then transmit the equipment operations parameter data 526 to the DCU 516.

The plurality of sensors 514 may be provided within the DCU 516 or may be external to the DCU 516 and within the pumps 101. The plurality of sensors 514 may be implemented as motion transducers, pressure potentiometers, capacitance transducers, piezoresistive sensors, electropneumatic transducers, temperature sensors, accelerometers, and flow rate sensors, for example. The plurality of sensors 514 may measure the one or more equipment operation parameters 526 in an analogue format, such as a wave form. In one embodiment, the plurality of sensors 514 may comprise one or more of the sensor types described above for each of the pumps 101.

The DCU 516 may receive equipment operations parameter data 526 from one or more of the plurality of sensors 514, which may be in the form of one or more real-time analogue data streams as shown in FIG. 8. The DCU 516 may be provided with one or more processors, non-transitory computer readable medium, computer executable instructions, an input device for receiving equipment operations parameter data 526, and an output device for transmitting the equipment operations parameter data 526 from the plurality of sensors 514 to the CEG 554. The DCU 516 may aggregate the equipment operations parameter data 526 from the plurality of sensors 514 for transmission. The DCU 516 may then transmit the received equipment operations parameter data 526 to the CEG 554. The CEG 554 may encapsulate the equipment operations parameter data 526 in a networking protocol framework, such as TCP/IP and then transmit the encapsulated equipment operations parameter data 526 to the network 512 via its communications device 518. The communications device 518 may be implemented similarly to communications devices 508 and 550, described above.

The central hub 502 may be implemented similarly to the MTU 506. The central hub 502 may be connected via a network to one or more management terminal 531, enabling the transmission of the management operations data 528 from a central location through a reliable network connection to the management terminal 531, thereby preventing gaps in the display of the management operations data 528 on the management terminal 531. In one embodiment, the central hub 502 may be implemented as a MTU 506 located at a location with a reliable network connection sufficient to provide reliable communications between the central hub 502 and the management terminal 531.

The management terminal 531 may be similarly to the MTU 506 with the exception that the management terminal 531 may not maintain a connection to a local communications network communicating with equipment 101.

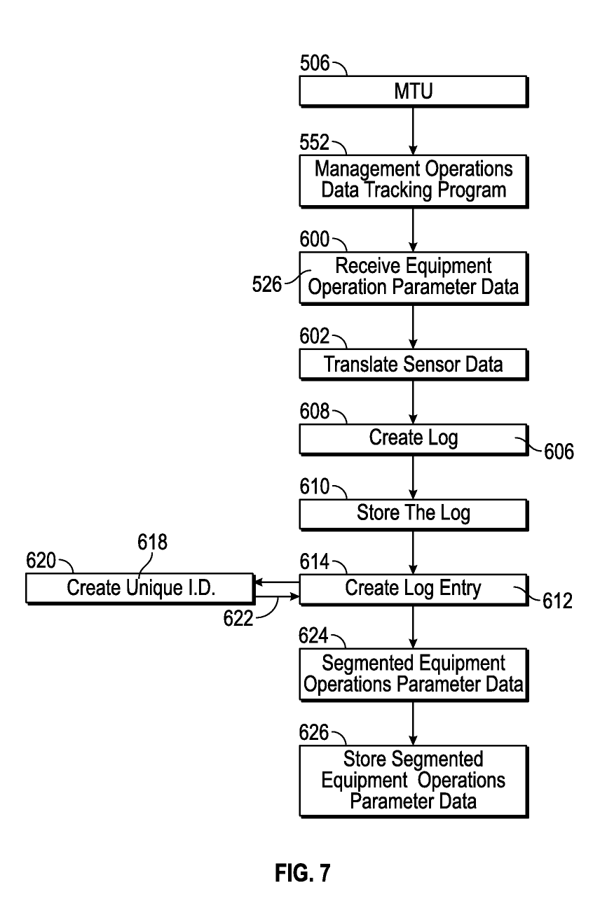

Referring now to FIGS. 7-9, the MTU 506 may implement the management data tracking program 552. The management data tracking program 552 may receive equipment operation parameter data 526 from the MTU 506 at 600. The management data tracking program 552 may translate the equipment operation parameter data 526 at 602 relative to a threshold level 604. The management data tracking program 552 may create one or more log 606 for certain ones of the pumps 101 located locally to the MTU 506 at 608. After creating the one or more log 606 for each of the pumps 101 local to the MTU 506, the management data tracking program 552 may store the one or more log 606 as shown by block 610 for certain ones of the pumps 101 local to the management data tracking program 552 in the non-transitory computer readable medium 534. The management data tracking program 552 may create one or more log entry 612 at 614 for one or more threshold event 616 with the one or more log entry 612 having a unique identification code 618 as shown by block 620, and store the unique identification code 618 in the one or more log entry 612 as shown by block 622. The management data tracking program 552 may segment the translated equipment operation parameter data 526 as shown by block 624 to facilitate its transmission across the network 548 to the central hub 502. The management data tracking program 552 may then store the segmented translated equipment operation parameter data 526 as shown by block 626.

Translating the equipment operation parameter data 526 as shown by block 600, as shown in FIG. 8, may be performed relative to the threshold level 604 to create translated data indicative of the operating status of the equipment at sequential instants of time. As shown in FIG. 8, the threshold level 604 is shown along with a baseline 628. The threshold level 604 and baseline 628 may represent values for pressure, temperature, flow rate, hours of operation, start time of operation, and end time of operation, for example. The threshold level 604 and baseline 628 may be representative of the same operation parameter as the equipment operation parameter data 526. Translating the equipment operation parameter data 526 relative to the threshold level 604 may summarize the equipment operation parameter data 526 such that the MTU 506 may determine times at which the equipment operation parameter data 526 intersects the threshold level 604. The intersection of the equipment operation parameter data 526 with the threshold level 604 is a threshold event 630. The threshold event 630 may occur where the equipment operation parameter data 526 rises above the threshold level 604 or falls below the threshold level 604.

For certain ones of the pumps 101 local to the MTU 506, communicating via the local communications network 512, the MTU 506 may create the log 606 as shown by block 608. The management data tracking program 552 may store data indicative of one or more threshold event 630 in the log 606. The log 606 may be stored in the non-transitory computer readable medium 534. In one embodiment, the log 606 may be stored in the local version of the redundant distributed database 530.

The one or more log entry 612 created for the one or more threshold event 630 may be stored within the log 606 in the redundant distributed database 530. The one or more log entry 612 may comprise data indicative of a start time 632, indicating the time of a first threshold event 634; a last modified time 636; and an end time 638, indicating the time of a second threshold event 640. Each of the first threshold event 634 and second threshold event 640 may be assigned a unique identification code 618. The one or more log entry 612 may also comprise equipment identification 401 and MTU identification 642.

The management data tracking program 552 receiving equipment operation parameter data 526 indicative of the first threshold event 634 may cause the management data tracking program 552 to create the log entry 612, storing within the log entry 612 data indicative of the first threshold event 634 such as the start time 632 and the unique identification code 618 for the first threshold event 634. Once created, the log entry 612 may be stored within the log 606 in the redundant distributed database 530. The management data tracking program 552 may then update the log entry 612 at time intervals 644 with the last modified time 636. Data indicative of the last modified time 636 may be overwritten with each successive update of the log entry 612. Upon receiving equipment operation parameter data 526 indicative of the second threshold event 640, the management data tracking program 552 may update the log entry 612, storing within the log entry 612 data indicative of the second threshold event 640 such as the end time 638 and the unique identification code 618 for the second threshold event 640. The management data tracking program 552 may overwrite the last modified time 636 with the end time 638 upon receiving equipment operation parameter data 526 indicative of the second threshold event 640. A subsequent threshold event 646 occurring after the second threshold event 640 for the same equipment 101 may be treated by the management data tracking program 552 as another first threshold event 634 creating a new log entry 648, similar to the creation and update of the log entry 612 described above.

The unique identification code 618 may be created as a globally unique identifier, where the unique identification code 618 may be generated by combining a media access control address for the equipment 101 related to the threshold event 630, the time of the threshold event 630, and a random or semi-random number. The unique identification code 618 may also be created through random generation of a hexadecimal or number; a cryptographic algorithm; or use of a hash function relative to the equipment identification 401, time, and location, for example. It will be understood that the unique identification code 618 may be suitably generated by any method or algorithm which creates a unique identification code 618 for a plurality of threshold events without repetition or collision of the plurality of unique identification codes 618.

The management data tracking program 552 may then segment the equipment operation parameter data 526 that has been translated as indicated by a block 624 to create a first segmented translated data and a second segmented translated data indicative of the operating status of the equipment at different periods of time for transmission to the central hub 502. Segmenting the equipment operation parameter data 526 within the one or more log entry 612 may be performed by dividing the equipment operation parameter data 526 that has been translated relative to the threshold level 604 based on a time interval 644. The translated equipment operation parameter data 526 may be segmented based on the time interval 644 between the start time 632 and the last modified time 636, where a segment 650 of the translated equipment operation parameter data 650 may represent the log entry 612. The segmentation of the translated equipment operation parameter data 526 may create management operations data 652, in the form of the one or more log entry 612. The segmentation may further serve to packetize the equipment operation parameter data 526, to facilitate reliably transmitting the management operations data 528 from wellsite operations to the central hub 502. The segmented translated equipment operation parameter data 650 may be stored within the one or more log entry for each of the pumps 101.

As shown in FIG. 9, the MTU 506 may display the equipment operation parameters data 526 as management operations data 528 translated from the equipment operation parameter data 526 for certain ones of the pumps 101 at a particular wellsite and in an organized manner so that a manager can readily see which of the pumps 101 are currently operating as well as historical information about the pumps 101. The MTU 506 may indicate pump 101 associated with the equipment operation parameter data 526 as “on” where the equipment operation parameter data 526 rises above the threshold level 604. The MTU 506 may then indicate the pump 101 associated with the equipment operation parameter data 526 as “off” where the equipment operation parameter data 526 falls below the threshold level 604. For example, where the equipment operation parameter data 526 is representative of a flow rate in barrels of fluid per minute and the threshold level 604 set at 50 barrels per minute, the MTU 506 indicate the pump as “on” when the equipment operation parameter data 526 rises above 50 barrels per minute. The MTU 506 may continue to indicate the pump as “on” while the equipment operation parameter data 526 remains above the threshold level 604 of 50 barrels per minute, whether the equipment operation parameter data 526 indicates flow rate of 51 barrels per minute or 83 barrels per minute. The MTU 506 may indicate the pump as “off” when the equipment operation parameter data 526 falls to 49 barrels per minute, below the 50 barrel per minute threshold level 604. First indicia indicative of the first operating status of the first equipment being above a threshold level (e.g., “on”), and second indicia indicative of the first operating status of the first equipment being below the threshold level (e.g., “off”) can be displayed by the MTU 506 as shown in FIG. 9. The Management terminal 531 can be configured in a similar manner as the MTU 506 to display the equipment operation parameters data 526 as management operations data 528 translated from the equipment operation parameter data 526 for certain ones of the pumps 101 at a particular wellsite and in an organized manner so that a manager can readily see which of the pumps 101 are currently operating as well as historical information about the pumps 101.

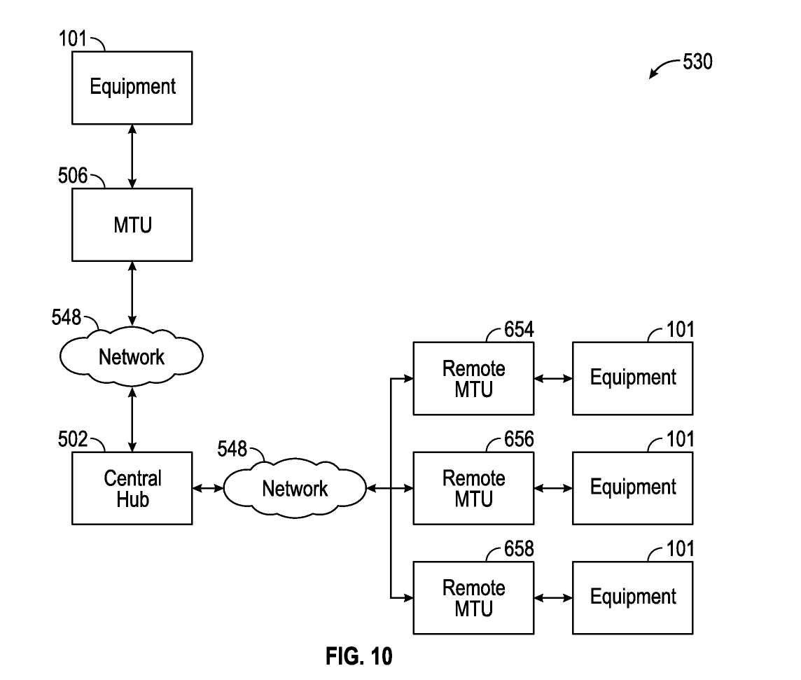

Referring now to FIG. 10, a redundant distributed database 530 may be created, as described above on the central hub 502 and the MTU 506. The redundant distributed database 530 may be a database having a plurality of MT units, for example MTU 506 and a plurality of remote MT units 654-658, acting as database servers, interconnected by the network 548 through the central hub 502, where each of the plurality of MTU 506 and 654-658 and the central hub 502 store a local version of the redundant distributed database 530 on one or more of the non-transitory computer readable medium 534 collocated with and coupled to the respective MTU 506 and 654-658 and the central hub 502. The plurality of MTU 506 and 654-658 may transmit locally received equipment operation parameter data 526, in the form of locally generated management operations data 528, to the central hub 502 via the network 548 to populate the local version of the redundant distributed database 530 located at the plurality of MTU 506 and 654-658 and the central hub 502. It will be understood by one skilled in the art that since each of the plurality of MTU 506 and 654-658 and the central hub 502 may be implemented similarly and each of the plurality of MTU 506 and 654-658 and the central hub 502 may contain a local version of the redundant distributed database 530, the MTU 506 may connect directly with the plurality of MTU 654-658 and the central hub 502 without directing communication initially through the central hub 502. In this embodiment, the plurality of MTU 506 and 654-658 and the central hub 502 may operate in a peer to peer architecture as opposed to a centralized central hub 502 served architecture.

The plurality of remote MTU 654, 656, and 658 and the central hub 502 may be implemented as described above with reference to the MTU 506. Stored on the non-transitory computer readable mediums 534 of the plurality of MTU 506 and 654-658 and the central hub 502, the redundant distributed database 530 may comprise the one or more logs 606 which contain the plurality of the equipment operation parameters 526 for the pumps 101. Therefore, the plurality of MTU 506 and 654-658 may interchangeably employ the pumps 101 without necessitating rebuilding of the one or more log 606 for the pumps 101 thereby providing an operational history for each of the pumps 101 at each of the plurality of MTU 506 and 654-658.

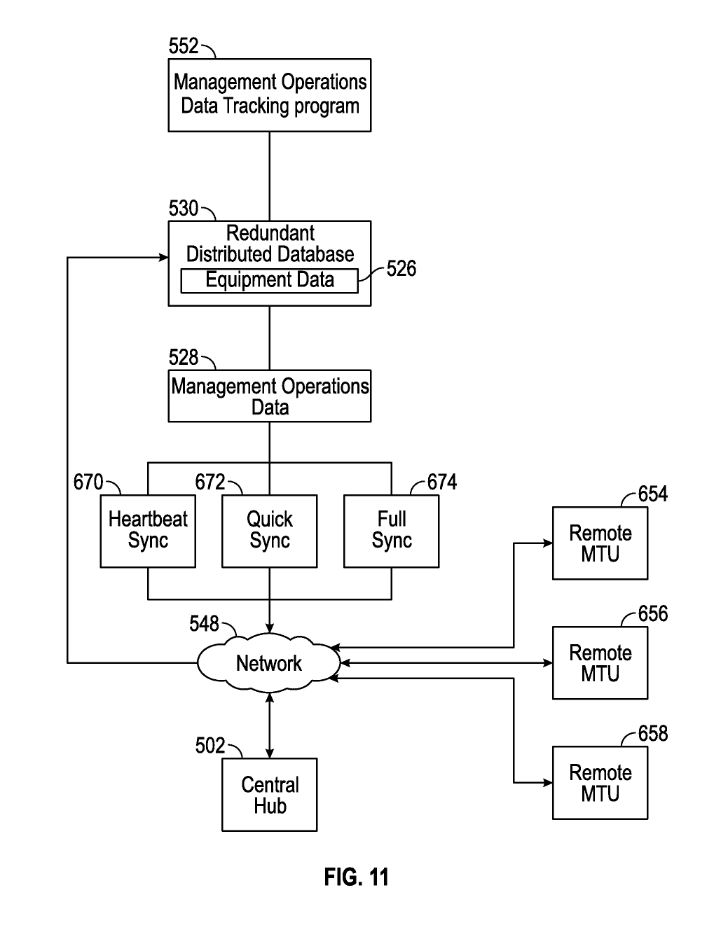

Referring now to FIG. 11, in operation, upon creating the log 606 and a first of the one or more log entry 612, the management data tracking program 552 may perform data synchronization via the network 548. In one embodiment, the management data tracking program 552 may perform a heartbeat synchronization 670, a quick synchronization 672, and a full synchronization 674. The data synchronization may be performed based on a time interval, based on availability of a connection to the network 548, or in response to a data loss event 676. The periodic data synchronization, using the heartbeat synchronization 670, quick synchronization 672, and full synchronization 674, may reliably transmit operation vitals data 680 and management operations data 528 across an unreliable connection to the network 548 by transmitting queries between the plurality of MTU 506 and 654-658 and the central hub 502 to identify and remediate gaps or deficiencies within copies of the redundant distributed database 530 located on the plurality of MTU 506 and 654-658 and the central hub 502. It will be understood by one skilled in the art that the heartbeat synchronization 670, quick synchronization 672, and full synchronization 674 may be performed similarly by each of the plurality of MTU 506 and 654-658 and the central hub 502, and for the sake of clarity, the heartbeat synchronization 670, quick synchronization 672, and full synchronization 674 will be discussed with regards to the MTU 506, but, in one embodiment, applying to the plurality of MTU 506 and 654-658 and the central hub 502.

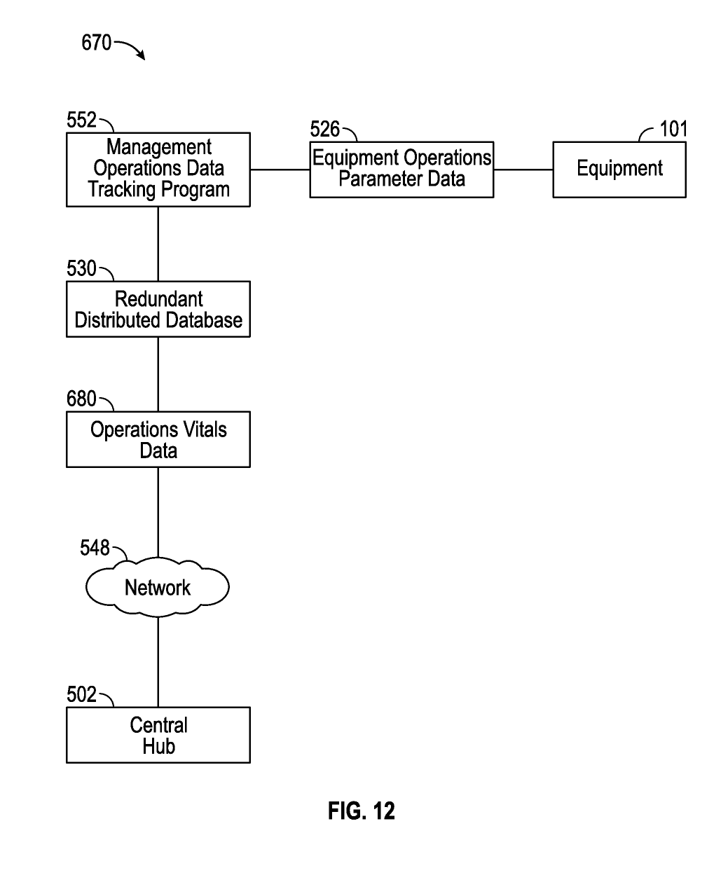

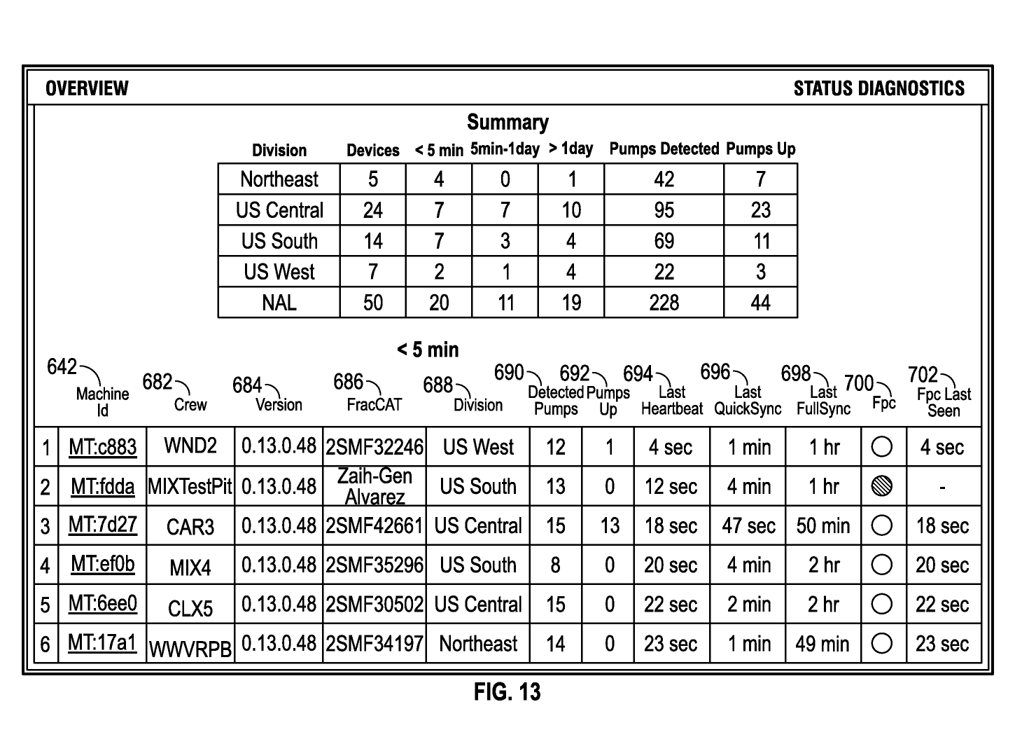

Referring now to FIGS. 12 and 13, in one embodiment, the management data tracking program 552 may perform the heartbeat synchronization 670. The heartbeat synchronization 670 may comprise transmitting operation vitals data 680 to the central hub 502 based on a time interval or availability of the connection to the network 548. The heartbeat synchronization 670 may be performed, for example, at time intervals of one minute. The heartbeat synchronization 670 may provide the central hub 502 with operation vitals data 680 comprising identification, operation, capacity, and synchronization history, for example. The heartbeat synchronization 670

The operation vitals data 680 provided by the heartbeat synchronization 670 to the central hub 502 may comprise data indicative of the MTU identification 642, a crew identification 682, a management data tracking program version 684, a mobile MTU platform identification 686, a location 688, a number of detected pumps 690, a number of pumps in operation 692, a last heartbeat synchronization time 694, a last quick synchronization time 696, a last full synchronization time 698, a FPC operation indicator 700, and a FPC last contact time 702, for example. The MTU identification 642 may be a unique identification for the MTU 506 performing the heartbeat synchronization 670. The crew identification 682 may be a unique identification for the users operating the hydraulic fracturing operations local to the MTU 506. The management data tracking program version 684 may comprise an identification number for the version of the management data tracking program currently in use in the MTU 506. Where the MTU 506 is implemented on a mobile platform, such as a frac van which in one embodiment takes the form of the computerized control system 229, the mobile platform may be assigned the mobile MTU platform identification 686, to maintain distinction as to which mobile platform is associated with which MTU 506 and pumps 101. In addition, the heartbeat synchronization 670 may transmit data indicative of the location 688 of the mobile platform. The location 688 may be represented by a geographic division, longitude and latitude, country, state, or any other suitable location designation.

The data indicative of the detected pumps 690 may comprise the number of the pumps 101 local to the MTU 506 to which the management data tracking program 552 may be able to receive data. The number of pumps in operation 692 may comprise data indicative of the number of the pumps 101 from which the management data tracking program 552 has received data. The last heartbeat synchronization time 694 may be indicative of the time at which the management data tracking program 552 last transmitted the heartbeat synchronization 670 to the central hub 502. The last quick synchronization time 696 may be indicative of the time at which the management data tracking program 552 last transmitted the quick synchronization 672 to the central hub 502. The last full synchronization time 698 may be indicative of the time at which the management data tracking program 552 last transmitted the full synchronization 674 to the central hub 502.

The FPC operation indicator 700 may be data indicative of whether the management data tracking program 552 is in communication with the FPC 510 local to the MTU 506. The FPC last contact time 702 may be indicative of the time at which the management data tracking program 552 was last in communication with the FPC 510 local to the MTU 506. Where the FPC 510 is in communication with the MTU 506, the FPC last contact time 702 may be the same as the last heartbeat synchronization time 694. However, where the FPC 510 is not in communication with the MTU 506, the management data tracking program 552 may continue to perform subsequent heartbeat synchronizations 670, quick synchronizations 672, and full synchronizations 674.

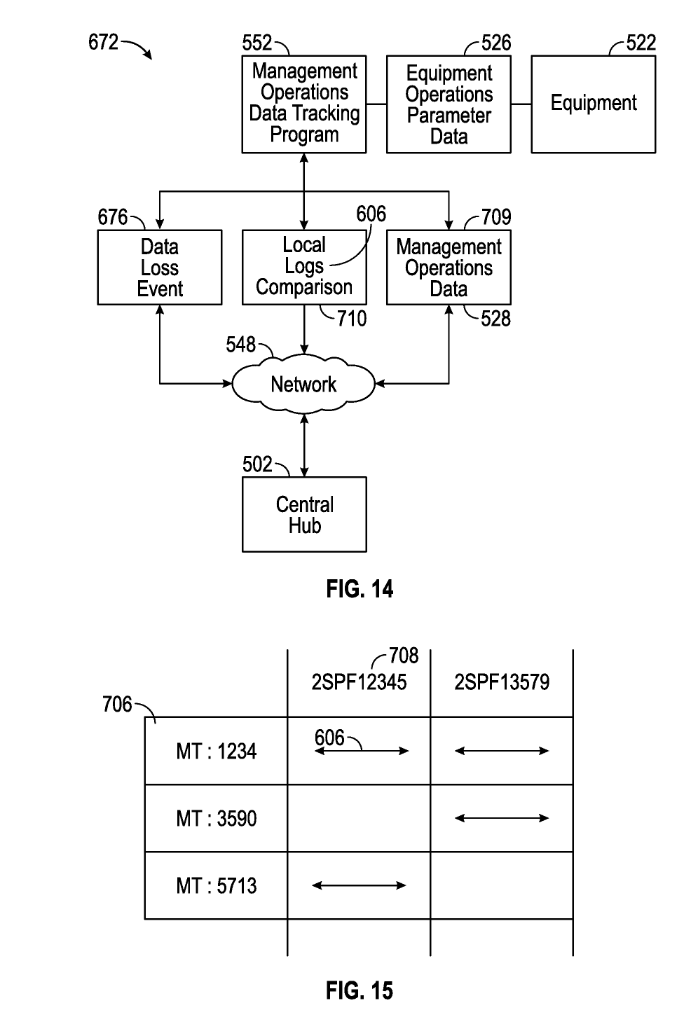

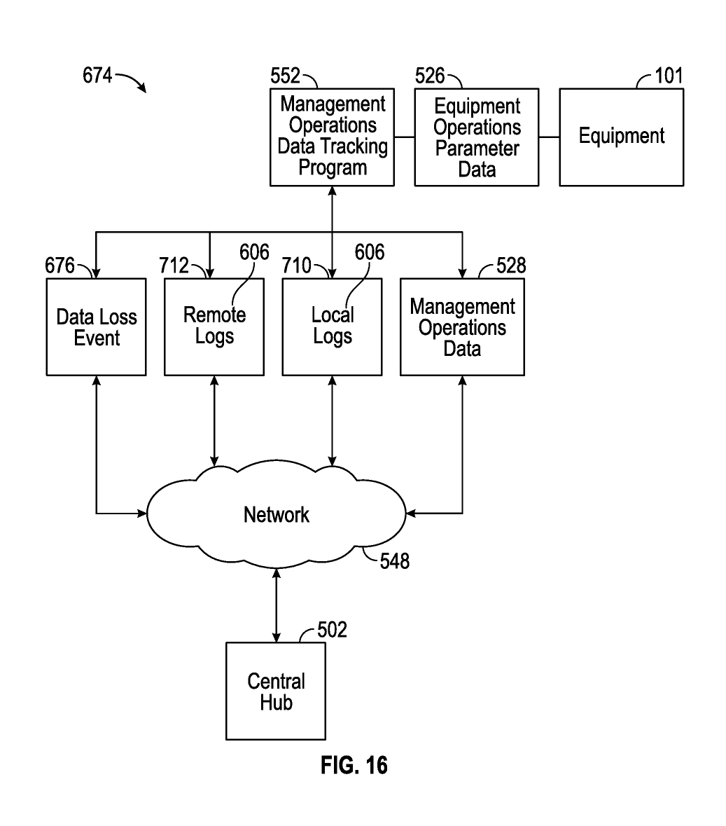

Referring now to FIG. 14, in one embodiment, the management data tracking program 552 may perform the quick synchronization 672. The quick synchronization 672 may comprise performing comparisons of one or more log 606, transmitting management operations data 528 to the central hub 502, and receiving management operations data 528 from the central hub 502. The quick synchronization 672 may be performed, for example, at intervals of five minutes, ten minutes, or other suitable time intervals; upon availability of the connection to the network 548; or in response to the data loss event 676. The quick synchronization 672 provides redundancy within the redundant distributed database 530 for management operations data 528 translated from equipment operations parameter data 526 generated from the pumps 101 local to the MTU 506.

Referring now to FIG. 15, in performing a synchronization, the management data tracking program 552 may compare one or more log 606 in order to determine whether gaps or data corruption exist within the local version of the redundant distributed database 530. The one or more log 606 may be organized by interrelation of a plurality of MTU 706 and a plurality of equipment 708, with each log 606 related to one of the plurality of MTU 706 and one of the plurality of equipment 708. Each of the one or more log 606 may comprise one or more log entry 612 for the one of the plurality of equipment 708 for which the log 606 was created containing data indicating the one of the plurality of MTU 706 to which the one of the plurality of equipment 708 is in communication. As described above, one or more log entry 612 may be stored in the log 606 representing the segmented translated equipment operations parameter data 526.

Referring again to FIG. 14, the quick synchronization 672 may fill gaps or remediate data corruption within the redundant distributed database 530, for the pumps 101 local to the MTU 506. At time intervals, the quick synchronization 672 may transmit the management operations data 528 stored in the logs 606 for the pumps 101 local to the MTU 506 shown in block 709. The MTU 506 may also transmit data related to comparison of local logs 606 for logs 606 of certain ones of the pumps 101 local to the MTU 506 shown in block 710. The data related to comparison of local logs 606 shown in block 710 transmits last modified times for the one or more log entry 612 of the logs 606 for the pumps 101 local to the MTU 506. The central hub 502 may compare the last modified times for the one or more log entry 612 stored within the logs 606 determining whether the version of the redundant distributed database 530 stored in the central hub 502 contains more recent last modified times for the one or more log entry 612. If the central hub 502 contains last modified times later than those transmitted for comparison by the MTU 506, the central hub 502 transmits the one or more log entry 612 for the logs 606 for which the central hub 502 has more recent data.

In response to a data loss event 676, the management data tracking program 552 may perform a quick synchronization 672 as described above to determine whether the data loss affected the locally generated management operations data 528, the locally associated equipment identification 401 data, remotely generated management operations data 528, or remotely located equipment identification 401 data, or combinations thereof, for example. Where the data loss affects the locally generated management operations data 528 or the locally associated equipment identification 401, the management data tracking program 552 may perform a quick synchronization 672, as discussed above, to repopulate the lost data within the local version of the redundant distributed database. If the data loss affects the remotely generated management operations data 528 or the remotely located equipment identification data 401, the management data tracking program 552 may wait to synchronize the lost data until the next full synchronization 674, which will be described below.

The full synchronization 674 may be implemented similarly to the quick synchronization 672 described above, with the exception that the full synchronization 674 may be performed at intervals of one hour. The full synchronization 674 additionally may comprise performing a comparison of logs 606 shown in block 712 for the logs 606 of certain ones of the pumps 101 remote from the MTU 506. The comparison of the logs 606 shown in block 712 for the remote pumps 101 is similar to the comparison of logs 606 for local pumps 101 shown in block 710 with the exception that the comparison of the logs 606 for remote pumps 101 compares the one or more log entry 612, for certain ones of the pumps 101 remote from the MTU 506, stored in the local version of the redundant distributed database 530 with the version of the redundant distributed database 530 stored on the central hub 502 to determine if the local version of the redundant distributed database 530 contains the logs 606 stored in the version of the redundant distributed database 530 on the central hub 502. If the central hub 502 contains data on its version of the redundant distributed database 530 not on the local version for the MTU 506, the central hub 502 transmits the logs 606 for the missing, corrupted, or less current data.

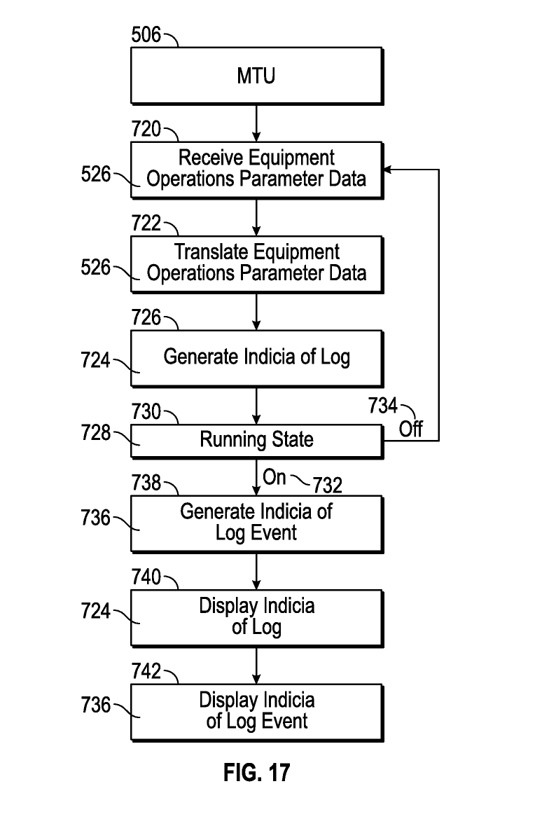

Referring now to FIGS. 9, 13 and 17, therein shown is a method for translating and displaying management operations data 528 from equipment operations parameter data 526. Although applying to the plurality of MTU 506 and 654-658 (which may be referred to herein as a first maintenance unit, a second maintenance unit, or the like) and the central hub 502, the method will be explained in reference to the MTU 506 for the sake of clarity. The management data tracking program 552 of the MTU 506 may receive equipment operations parameter data 526 as shown by block 720. As described above, the management data tracking program 552 translates the equipment operations parameter data 526 as shown by block 722 relative to one or more threshold level 604. The management data tracking program 552 may create the log 606 as described above for certain ones of the pumps 101 in communication with the MTU 506. Once the log 606 has been created, the management data tracking program 552 may generate indicia 724 of the log 606. The management data tracking program 552 may then determine a running state 728 shown by block 730. For the pumps 101 which are in communication with the MTU 506 and operating above the threshold level 604, the management data tracking program 552 may create the one or more log entry 612, as described above. Once the log 606 and the one or more log entry 612 has been created, the management data tracking program 552 may generate indicia 736 of the one or more log entry 612 shown by block 738. The generated indicia 724 and 736 may be displayed as shown by blocks 740 and 742, respectively.

The running state 728 (which may also be referred to herein as an operating status) may be determined for the pumps 101 in communication with the MTU 506 which are in operation or not in operation. The management data tracking program 552 may determine the running state 728 as “running” or “on” shown at 732. The “on” running state shown at 732 may indicate that certain ones of the pumps 101 are operating above the threshold level 604. The running state 728 may be determined at the intersection of the equipment operations parameter data 526 with the one or more threshold level 604, indicating the threshold event 616. In one embodiment, as shown in FIG. 9, when the flow rate in barrels per minute for certain ones of the pumps 101 rise above the threshold level flow rate, the management data tracking program 552 indicates the certain ones of the pumps 101 are in the “on” running state 728. When the running state 728 is “not running” or “off” shown at 734, the certain ones of the pumps 101 are not operating above the threshold level 604 but may still be in communication with the MTU 506. When the running state 728 is “off” the management data tracking program 552 may still receive equipment operations parameter data 526 from the pumps 101 in the “off” running state 728. When the flow rate falls below the threshold level 604, the management data tracking program 552 indicates the certain ones of the pumps 191 are in the “off” running state 728 and maintains the receipt and translation of equipment operations parameter data 526.

The indicia 724 may comprise a graphical indication of pumps 101 in communication with the MTU 506 which have had the log 606 created. The indicia 736 may comprise a graphical indication of the one or more log entry 612 of certain ones of the pumps 101 which are currently operating above the threshold level 604. The graphical indication may comprise a text based indication, a visual indication (such as the bars shown in FIG. 9), or any other suitable graphical indication sufficient to illustrate certain ones of the pumps 101 in communication with the MTU 506 and certain ones of the pumps 101 in communication operating above the threshold level 604. In addition to the graphical indications described above, the indicia 724 and 736 may also comprise equipment identification 401, MTU identification 642, crew identification 682, location 688, and time data, for example.

As shown in FIG. 9, displaying the indicia 724 and 736 may comprise overlaying the graphical indication of the indicia 736 over the indicia 724, such that the graphical indication shows operations of certain ones of the pumps 101 over time in relation to the certain ones of the pumps 101 in communication with the MTU 506 and certain ones of the pumps 101 remote from the MTU 506. Displaying the indicia 724 and 736 may also comprise displaying the indicia 724 and 736 side by side; without the inclusion of certain ones of the pumps 101 remote from the MTU 506; and with the additional graphical indications for equipment identification 401, MTU identification 642, crew identification 682, and location 688, described above, for example.

It should be understood that (1) the term “processor”, as used in the claims, is intended to mean a single processor, or multiple processors, and (2) the term non-transitory computer readable medium, as used in the claims, is intended to mean a single non-transitory computer readable medium, or multiple non-transitory computer readable mediums.

Although the present disclosure has been described with reference to embodiments and implementations thereof, the present disclosure is not to be limited by or to such embodiments and/or implementations. Rather, the systems and methods of the present disclosure are susceptible to various modifications, variations and/or enhancements without departing from the spirit or scope of the present disclosure. Accordingly, the present disclosure expressly encompasses such modifications, variations and enhancements within its scope.

What is claimed is:

1. A maintenance tool unit, comprising:
a processor; and
a computer readable medium coupled to the processor, the computer readable medium being non-transitory and local to the processor, the computer readable medium storing computer executable instructions, that when executed by the processor cause the processor to:
receive first equipment operations parameter data indicative of a first operating status of a first equipment at a first location;
receive second operations parameter data indicative of a second operating status of a second equipment at the first location;
translate the first and second equipment operations parameter data relative to a threshold level;
segment the translated first and second equipment operations parameter data to create first segmented translated data indicative of the first equipment operations parameter data, and second segmented translated data indicative of the second equipment operations parameter data; and
store the first segmented translated data in a first log, on the computer readable medium, and the second segmented translated data in a second log on the computer readable medium, with the first and second logs being parts of a first database.

2. The maintenance tool unit of claim 1, wherein the first operating status is selected from a group comprising pressure, temperature, flow rate, hours of operation, start time, of operation, and end time of operation.

3. The maintenance tool unit of claim 1, wherein the first and second equipment operations parameter data includes equipment identification information.

4. The maintenance tool unit of claim 1, wherein the threshold level is selected from a group comprising a baseline pressure, baseline temperature, baseline flow rate, and baseline hours of operation.

5. The maintenance tool unit of claim 1, wherein the first log and the second log comprise data indicative of a start time and a last modified time.

6. The maintenance tool unit of claim 5, wherein the first log and the second log comprise data indicative of the start time, the last modified time, and an end time.

7. The maintenance tool unit of claim 6, wherein the last modified time corresponds with the end time.

8. The maintenance tool unit of claim 1, wherein segmenting the translated first and second equipment operations parameter data divides the translated first and second equipment operations parameter data based on a time interval, the time interval creating a start time, a last modified time, and an end time for the translated data.

9. The maintenance tool unit of claim 8, wherein the computer executable instructions, when executed by the processor causes the processor to create a first log entry for the first segmented translated data, and a second log entry for the second segmented translated data, the first and second log entries comprising data indicative of the start time, the last modified time, an equipment identification, and a maintenance tool unit identification.

10. The maintenance tool unit of claim 9, wherein the first log entry further comprises data indicative of a first unique identification code assigned to a first threshold event, and the second log entry further comprises data indicative of a second unique identification code assigned to a second threshold event.

11. The maintenance tool unit of claim 10, wherein the first and second threshold events are indicative of at least one of the first and the second equipment operations parameter data intersecting the threshold level.

12. The maintenance tool unit of claim 1, wherein the first location is a wellsite.

13. A method implemented by computer executable instructions running on a processor, the method comprising:
receiving data indicative of an operating status of equipment at sequential instants of time;
translating the data indicative of the operating status of the equipment relative to a threshold level to create translated data indicative of the operating status of the equipment at the sequential instants of time;
segmenting the translated data to create a first segmented translated data and a second segmented translated data indicative of the operating status of the equipment at different periods of time; and
storing the first and second segmented translated data within a log local to the processor.

14. The method of claim 13, wherein the operating status is selected from a group comprising pressure, temperature, flow rate, hours of operation, start time of operation, and end time of operation.

15. The method of claim 13, wherein the threshold level is selected from a group comprising a baseline pressure, baseline temperature, baseline flow rate, and baseline hours of operation.

16. The method of claim 13, wherein the log contains data indicative of a first start time and a first last modified time for the first segmented translated data, and a second start time and a second last modified time for the second segmented translated data.

17. The method of claim 16, wherein segmenting the translated data divides the translated data based on a time interval, the time interval creating the first and second start times and the first and second last modified times.

18. The method of claim 13, further comprising the step of creating a first log entry for the first segmented translated data, and a second log entry for the second segmented translated data, the first and second log entries comprising data indicative of a start time, a last modified time, and an equipment identification.

19. The method of claim 18, wherein the first log entry further comprises data indicative of a first unique identification code assigned to a first threshold event, and the second log entry further comprises data indicative of a second unique identification code assigned to a second threshold event.

20. The method of claim 19, wherein the first and second threshold events are indicative of the data indicative of the operating parameter of the equipment intersecting the threshold level.

21. The method of claim 13, wherein the equipment is wellsite equipment.

22. A system, comprising:
a first equipment at a first location;
a first maintenance tool unit at the first location, the first maintenance tool unit comprising:
a first processor; and
a first computer readable medium coupled to and local to the first processor, the first computer readable medium being non-transitory and storing first computer executable instructions, that when executed by the first processor causes the first processor to:
receive and store first management operations data indicative of first equipment operations parameter data indicative of a first operating status of a first equipment in a first log of a first database on the first computer readable medium, the first management operations data being translated and segmented from the first equipment operations parameter data;
store a first unique identification code identifying the first equipment, and a second unique identification code identifying the first maintenance tool unit in the first log;
a central hub having a second processor storing a second database on a second computer readable medium separate from the first computer readable medium, the second computer readable medium being non-transitory, the second processor synchronizing the first database with the second database, whereby the first log is stored in the second database; and
a second maintenance tool unit at a second location different from the first location, the second maintenance tool unit comprising a third processor storing a third database on a third computer readable medium being non-transitory and separate from the first and second computer readable mediums, the third processor synchronizing the third database with the second database, whereby the first log is stored in the third database.

23. The system of claim 22, wherein the first equipment operations parameter data is indicative of operating time of the first equipment above and below a threshold level.

24. The system of claim 22, wherein the first equipment operations parameter data is segmented based on a start time and a last modified time indicative of predetermined time intervals.

25. The system of claim 22, wherein synchronizing the first database with the second database is performed at predetermined time intervals.

26. The system of claim 22, wherein the processor of the central hub uses a last modified time of the first management operations data to determine a portion of data in the first log stored in the first database to synchronize with the second database.

27. The system of claim 22, wherein the first location is a first wellsite, and wherein the second location is a second wellsite.

28. A method, comprising:
creating a first database on a first computer readable medium being non-transitory and local to a first maintenance tool unit, and a second database on a second computer readable medium being non-transitory and local to a second maintenance tool unit;
storing management operations data indicative of equipment operations parameter data within the first and second databases, the equipment operations parameter data indicative of operating status of equipment located locally to the first and second maintenance tool units, and wherein the management operations data is created by translating and segmenting the equipment operations parameter data; and
synchronizing the management operations data stored in the first and second databases with a third database stored on a third computer readable medium at a central hub, the third computer readable medium being non-transitory.

29. The method of claim 28, wherein the equipment operations parameter data is indicative of operating time of pieces of equipment above and below a threshold level.

30. The method of claim 28, wherein the equipment operations parameter data is segmented based on a start time and a last modified time indicative of predetermined time intervals.

31. The method of claim 28, wherein synchronizing the first and second databases with the third database is performed at predetermined time intervals.

32. The method of claim 28, wherein synchronizing the first and second databases with the third databases uses a last modified time of the management operations data to determine the management operations data to be synchronized.

33. The method of claim 28, wherein the equipment is wellsite equipment.
